(19) United States
(12) Patent Application Publication
(10) Pub. No.: US 2023/0183461 A1
(43) Pub. Date: Jun. 15, 2023

(54) ETHYLENE-COPOLYMER RUBBERS

(71) Applicant: ARLANXEO NETHERLANDS B.V., RD Geleen (NL)

(72) Inventors: Maria Montserrat ALVAREZ GRIMA, KS Sittard (NL); John BEELEN, PX Heerlen (NL); Rafaele BERNARDO, CK Maastricht (NL); Christoph GOEGELEIN, Koeln (DE)

(73) Assignee: ARLANXEO NETHERLANDS B.V., RD Geleen (NL)

(21) Appl. No.: 17/925,497

(22) PCT Filed: May 12, 2021
(86) PCT No.: PCT/EP2021/062644

§ 371 Date: Nov. 15, 2022

(30) Foreign Application Priority Data
May 15, 2020 (EP) 20175017.1

(51) Int. Cl. C08L 23/16; C08L 91/00

(52) U.S. Cl. CPC C08L 23/16; C08L 91/00; C08L 2203/14

(57) ABSTRACT

A composition comprising an ethylene copolymer comprising units derived from ethylene, at least one C₃-C₂₀ α-olefin, and at least one non-conjugated diene, wherein the copolymer contains
(i) up to and including 58% by weight based on the total weight of the copolymer of units derived from ethylene, preferably from 35 to 56% by weight and more preferably from 38 to 52% by weight;
(ii) up to and including 57% by weight, preferably from 17 to 55% by weight, based on the total weight of the copolymer of units derived from the at least one C₃-C₂₀ α-olefins, preferably from propylene; wherein the ethylene copolymer has from about 80 up to about 125 units derived from the one or more diene per polymer chain and wherein the ethylene copolymer is mixed with the oil and the total amount of oil in the composition is 29 phr or less and wherein the composition contains from 60% by weight to 100% by weight, based on the total weight of the composition which is 100%, of ethylene copolymer and oil. Also provided are rubber compositions and rubber compounds and articles comprising the copolymer, and methods of making such articles, compositions and compounds.

The present disclosure relates to ethylene-copolymer rubbers and rubber compositions and to a process for manufacturing such rubbers and rubber compositions and articles made with such rubbers.

Ethylene-α-olefin-elastomers, and ethylene-propylene-diene copolymers (EPDM) in particular, are used in many applications. In one major application EPDM-type polymers are used as seals or as component of seals or sealing systems. EPDM rubbers are found in sealing systems in motor vehicles, water craft and aircraft vehicles, for example as sealing material for doors or windows—also referred in the art as ‘weatherstrip’ applications. In many transportation applications, the materials are required to be of low density and are typically provided as foamed materials, so called ‘sponges’. EPDM rubbers are also used to seal windows in buildings or as seals to make appliances airtight or watertight—for example as O-rings in water faucets or as seals or flanges for openings in washing machines and other equipment. Other applications of such rubbers include their use as belts, for example as conveyor belts, escalator belts, engine belts. Further applications include, for example, engine mounts, roofing and hoses.

Suitable rubbers for these applications need to have good mechanical properties, such as for example tensile strength, tear strength and also good flexibility, elasticity and form-retaining properties under static and also dynamic stress. When used in out-door applications these properties have to be maintained over a wide range of temperatures. In many applications, in particular sealing application, the rubbers also need to have good vibration or sound dampening properties, for example for dampening the sound of engines.

In most applications the EPDM rubbers are blended with at least one other ingredient to produce a so-called rubber ‘compound’. Such ingredients may be fillers, curing agents or blowing agents. It is known that the mechanical properties of EPDM rubbers, for example the tensile strength, increase with the molecular weight of the polymer. This creates the need to provide high molecular weight rubbers to achieve improved mechanical properties. However, rubbers with high molecular weight tend to be difficult to process in particular when making compounds or processing the compounds. Such difficulties can manifest themselves as poor mixing, difficult kneading and generation of aggregated lumps in compounds and the formation of rough surfaces during extrusion, molding or cutting curable or cured rubber compounds.

Several methods are known in the art to reduce these problems. One approach is to create a specific polymer architecture and microstructure, for example by controlling the molecular weight distribution or branching structure of the polymer. Another well-known approach is to add ingredients to the rubber composition that reduce its overall viscosity, for example by diluting the rubber composition with blending in other rubbers of lower viscosity. Alternatively, or in addition, oils can be added to the rubber to produce so-called “oil-extended polymers”. Oil-extended polymers are produced by blending the polymers either during their preparation or during their work up with one or more extender oil, i.e. before the polymer is isolated and dried. The extender oil is then homogeneously mixed with the polymer. Such oil-extended polymers can be easier processed to produce rubber compounds than providing the same polymer without oil but adding oil only during the process of making the rubber compounds.

In US patent application No 2017/0313868 A1 oil-extended EPDM polymers are described that have a molecular weight of at least 300,000 g/mole. The content of extender oil is from 30 to 70 phr. The rubber composition has good mechanical properties and also good vibration damping properties as determined by low delta min values at phase angle measurements. However, a high oil content leads to increased production costs. A high oil content can also reduce the dynamical performance of the rubber composition, especially if other ingredients are added to the rubber composition. This may limit the amount at which such ingredients, for example fillers or rubber additives, can be added to the rubber composition and reduces the operational window of the oil-extended EPDM polymer. In US patent application No 2019/0153206 A1 is described that at least some of these problems can be overcome by providing an ethylene-copolymer of a specific monomer composition and polymer architecture defined by the level of branching. The oil-extended rubber composition contains ethylene copolymers with a molecular weight of at least 400,000 g/mole and has good mechanical and form-retaining properties at a rather low oil content of from 10 to 40 phr. However, US 2019/0153206 A1 is silent about vibration and noise attenuation and dynamic properties, which are useful properties for sealing applications and in particular for foamed seals or sponge materials.

### SUMMARY

It has now been found that a composition containing an ethylene-copolymer of specific composition and structure, a composition containing it, can be processed into rubber compounds having even improved dynamic and mechanical properties.

In one aspect there is provided an ethylene copolymer containing

(i) from 35 up to and including 58% by weight of units derived from ethylene, preferably from 35 to 56% by weight and more preferably from 38 to 52% by weight;
(ii) from 17 up to and including 57% by weight, of units derived from the at least one C₃-C₂₀ α-olefins, and wherein the at least one C₃-C₂₀ α-olefin comprises propylene;
(iii) from 5 to 20% by weight of units derived from 5-ethylidene-2-norbornene (ENB), wherein the % by weight in (i) to (iii) are based on the total weight of the copolymer which 100% by weight and wherein the copolymer has more than 80 units derived from ENB per polymer chain determined according to the formula (I):

units derived from ENB=([ENB]×10×Polymer Mn)/120 g/mol (I)

wherein ‘[ENB]’ is the content of ENB units in the polymer in % by weight (based on the total weight of the polymer which is 100% by weight) and ‘Polymer Mn’ means the number average molecular weight (Mn) of the polymer, expressed in kg/mol.

In another aspect there is provided a method of making a rubber compound comprising mixing the composition comprising the ethylene copolymer with at least one curing agent, optionally at least one filler or a combination thereof.

In a further aspect there is provided a rubber compound obtained from that method.

In yet another aspect there is provided a method of making an article comprising subjecting the rubber compound to shaping and curing, wherein the shaping can be done after, prior to, or simultaneous with the curing.

In a further aspect there is provided an article obtained by that method.

In another aspect there is provided a method of making an oil-extended polymer composition comprising

(i) polymerizing ethylene, the at least one C₃-C₂₀ α-olefins, and the at least one non-conjugated diene in a reaction medium to provide an ethylene-copolymer,
(ii) mixing the ethylene copolymer with one or more oil in the reaction medium,
(iii) removing the reaction medium to isolate a composition comprising the copolymer and the oil,
(iv) optionally, subjecting the composition to at least one of the steps selected from drying, shaping, compressing, washing and a combination thereof.

### BRIEF DESCRIPTION OF THE FIGURES

FIG. 1 is a van Gurp-Palmen plot obtained from DMTA measurements with the polymer of example 1 as described in the experimental section. The dashed lines show the minimum phase angle and the corresponding absolute modulus, δₘᵢₙ and δₘᵢₙ, respectively.

FIG. 2 is plot of loss factor (tan delta) versus frequencies obtained from the dynamic-mechanical analysis described in the experimental section.

### DETAILED DESCRIPTION

In the following description norms may be used. If not indicated otherwise, the norms are used in the version that was in force on Mar. 1, 2020. If no version was in force at that date because, for example, the norm has expired, then the version is referred to that was in force at a date that is closest to Mar. 1, 2020.

In the following description the amounts of ingredients of a composition or polymer may be indicated interchangeably by “weight percent”, “wt. %” or “% by weight”. The terms “weight percent”, “wt. %” or “% by weight” are used interchangeably and are based on the total weight of the composition or polymer, respectively, which is 100% unless indicated otherwise. When amounts of units derived from a monomer or other ingredients of the polymer are expressed in % by weight based on the weight of copolymer and the copolymer is oil-extended the total weight of the copolymer still refers to the total weight of the copolymer. In other words, the total weight of copolymer of an oil-extended copolymer is the weight of the copolymer and the extender oil minus the weight of the extender oil.

The term “phr” means parts per hundred parts of rubber, i.e. the weight percentage based on the total amount of rubber which is set to 100% by weight. The ethylene-copolymer according to the present disclosure is a rubber. If a composition contains one or more ethylene-copolymer or one ethylene-copolymer and one or more other rubbers, the “phr” refer to the total amount of these rubbers.

Ranges identified in this disclosure include and disclose all values between the endpoints of the range and also include the end points unless stated otherwise.

The words “comprising” and “containing” are used interchangeably. They are meant to include the ingredients or components to which they refer but do not exclude the presence of other ingredients or components. The word “consisting” is used in a limiting sense to is meant to limit a composition to only those ingredients to which the word consisting refers.

### Ethylene-α-Olefin-Copolymers

The ethylene-α-olefin-copolymers provided herein can be used to provide compounds having good properties, in particular good dynamic properties useful in particularly for sealing applications, as represented for example by low tan delta values, high rebound values, low compression sets, low dynamic stiffness and having good mechanical properties like tensile strength and elastic properties like elongation at break. Despite having high molecular weights, they can be processed into rubber compounds by using no or only low amounts of extender oils.

An ethylene-α-olefin-copolymer according to the present disclosure is a copolymer of ethylene and at least two further comonomers. This means the copolymer comprises repeating units derived from ethylene and the at least two further comonomers. Preferably, the copolymer comprises up to 58 percent by weight (wt. %) of units derived from ethylene. More preferably, the copolymer according to the present disclosure comprises up to 56% by weight and more preferably up to 52% by weight of units derived from ethylene. In one embodiment the ethylene-α-olefin-copolymer of the present disclosure comprises from 35 to 56 wt. %, preferably from 38 to 52 wt. % of units derived from ethylene. The weight percentages are based on the total weight of the copolymer.

In addition to units derived from ethylene, the copolymer according to the present disclosure has repeating units derived from (i) one or more C₃-C₂₀-α-olefin, preferably a C₃-C₁₂-α-olefin, (ii) at least one non-conjugated diene, and (iii) at least one dual polymerizable diene.

C₃-C₂₀-α-Olefins

C₃-C₂₀-α-olefins (also referred to herein as“C₃-C₂₀ alpha olefins”) are olefins containing three to twenty carbon atoms and having a single aliphatic carbon-carbon double bond. The double bond is located at the terminal front end (alpha-position) of the olefin. The α-olefins can be aromatic or aliphatic, linear, branched or cyclic. Examples include propylene, 1-butene, 1-pentene, 1-hexene, 1-heptene, 1-octene, 1-nonene, 1-decene, 1-undecene, 1-dodecene, 1-tridecene, 1-tetradecene, 1-pentadecene, 1-hexadecene, 1-hepta-decene, 1-octadecene, 1-nonadecene, 1-eicosene, 3-methyl-1-butene, 3-methyl-1-pentene, 3-ethyl-1-pentene, 4-methyl-1-pentene, 4-methyl-1-hexene, 4,4-dimethyl-1-hexene, 4,4-dimethyl-1-pentene, 4-ethyl-1-hexene, 3-ethyl-1-hexene, 9-methyl-1-decene, 11-methyl-1-dodecene and 12-ethyl-1-tetradecene. The alpha olefins may be used in combination. Preferred alpha-olefins are aliphatic C₃-C₁₂ α-olefins, more preferably aliphatic, linear C₃-C₂₀ α-olefins, most preferably propylene (a C₃ α-olefin) and 1-butene (C₄ α-olefin). Preferably, the ethylene-α-olefin-copolymer of the present disclosure contains propylene and one or more than one other C₃-C₂₀-α-olefins. In one embodiment of the present disclosure the ethylene-α-olefin-copolymer contains only propylene as C₃-C₂₀-α-olefin. Preferably, the ethylene-copolymer contains up to 57 wt. %, more preferably up to 55 wt. % of units derived from the C₃-C₂₀ α-olefins (all weight percentages (wt. %) are based on the total weight of the copolymer). Preferably, the ethylene-α-olefin-copolymer contains from 17 to 57 wt. % of total units derived from C₃-C₂₀ α-olefins. Preferably, the ethylene-α-olefin-copolymer contains up to 57 wt. %, more preferably up to 55 wt. % of units derived from propylene (all weight percentages (wt. %) are based on the total weight of the copolymer). In one embodiment of the present disclosure the ethylene-α-olefin-copolymer contains from 17 to 55 wt. % of total units derived from propylene.

### Non-Conjugated Dienes

Non-conjugated dienes are polyenes comprising at least two double bonds, the double bonds being non-conjugated in chains, rings, ring systems or combinations thereof. The polyenes may have endocyclic and/or exocyclic double bonds and may have no, the same or different types of substituents. The double bonds are at least separated by two carbon atoms. To a significant extent only one of the non-conjugated double bonds is converted by a polymerization catalyst. The non-conjugated dienes are preferably aliphatic, more preferably alicyclic and aliphatic.

Suitable non-conjugated dienes include aromatic polyenes, aliphatic polyenes and alicyclic polyenes, preferably polyenes with 6 to 30 carbon atoms (C₆-C₃₀-polyenes, more preferably C₆-C₃₀-dienes). Specific examples of non-conjugated dienes include 1,4-hexadiene, 3-methyl-1,4-hexadiene, 4-methyl-1,4-hexadiene, 5-methyl-1,4-hexadiene, 4-ethyl-1,4-hexadiene, 3,3-dimethyl-1,4-hexadiene, 5-methyl-1,4-heptadiene, 5-ethyl-1,4-heptadiene, 5-methyl-1,5-heptadiene, 6-methyl-1,5-heptadiene, 5-ethyl-1,5-heptadiene, 1,6-octadiene, 4-methyl-1,4-octadiene, 5-methyl-1,4-octadiene, 4-ethyl-1,4-octadiene, 5-ethyl-1,4-octadiene, 5-methyl-1,5-octadiene, 6-methyl-1,5-octadiene, 5-ethyl-1,5-octadiene, 6-ethyl-1,5-octadiene, 1,6-octadiene, 6-methyl-1,6-octadiene, 7-methyl-1,6-octadiene, 6-ethyl-1,6-octadiene, 6-propyl-1,6-octadiene, 6-butyl-1,6-octadiene, 4-methyl-1,4-nonadiene, 5-methyl-1,4-nonadiene, 4-ethyl-1,4-nonadiene, 5-ethyl-1,4-nonadiene, 5-methyl-1,5-nonadiene, 6-methyl-1,5-nonadiene, 5-ethyl-1,5-nonadiene, 6-ethyl-1,5-nonadiene, 6-methyl-1,6-nonadiene, 7-methyl-1,6-nonadiene, 6-ethyl-1,6-nonadiene, 7-ethyl-1,6-nonadiene, 7-methyl-1,7-nonadiene, 8-methyl-1,7-nonadiene, 7-ethyl-1,7-nonadiene, 5-methyl-1,4-decadiene, 5-ethyl-1,4-decadiene, 5-methyl-1,5-decadiene, 6-methyl-1,5-decadiene, 5-ethyl-1,5-decadiene, 6-ethyl-1,5-decadiene, 6-methyl-1,6-decadiene, 6-ethyl-1,6-decadiene, 7-methyl-1,6-decadiene, 7-ethyl-1,6-decadiene, 7-methyl-1,7-decadiene, 8-methyl-1,7-decadiene, 7-ethyl-1,7-decadiene, 8-ethyl-1,7-decadiene, 8-methyl-1,8-decadiene, 9-methyl-1,8-decadiene, 8-ethyl-1,8-decadiene, 1,5,9-decatriene, 6-methyl-1,6-undecadiene, 9-methyl-1,8-undecadiene, dicyclopentadiene, and mixtures thereof. Dicyclopentadiene can be used both as dual polymerizable or as non-conjugated diene, in which case dicyclopentadiene is used in combination with at least one dual polymerizable diene or at least one non-conjugated diene.

Preferred non-conjugated dienes include alicyclic polyenes. Alicyclic dienes have at least one cyclic unit. In a preferred embodiment the non-conjugated dienes are selected from polyenes having at least one endocyclic double bond and optionally at least one exocyclic double bond. Preferred examples include dicyclopentadiene, 5-methylene-2-norbornene and 5-ethylidene-2-norbornene (ENB) with ENB being particularly preferred. In one embodiment the copolymer of the present disclosure contains only ENB as non-conjugated diene.

Examples of aromatic non-conjugated polyenes include vinylbenzene (including its isomers) and vinyl-isopropenylbenzene (including its isomers).

In a typical embodiment of the present disclosure the copolymer contains at least 5 wt. and up to and including 20 wt. % of units derived from the one or more non-conjugated diene. In a preferred embodiment, the copolymer contains from 6 to 18 wt. % of units derived from the one or more non-conjugated dienes, more preferably from 7 to 18 wt. %, for example from 8 to 15 wt. %. In a preferred embodiment the copolymer contains from 5 wt. and up to 20% wt. % of units derived from ENB, and, more preferably from 6 to 18 wt. of units derived from ENB, or from 7 to 18 wt. %, for example from 8 to 15 wt. %, of units derived from ENB (all wt. % based on the total weight of the ethylene-α-olefin-copolymer).

### Dual Polymerizable Dienes

Dual polymerizable dienes are selected from vinyl substituted aliphatic monocyclic and non-conjugated dienes, vinyl substituted bicyclic and unconjugated aliphatic dienes, alpha-omega linear dienes and non-conjugated dienes where both sites of unsaturation are polymerizable by a coordination catalyst (e.g. a Ziegler-Natta Vanadium catalyst or a metallocene-type catalyst). Examples of dual polymerizable dienes include 1,4-divinylcyclohexane, 1,3-divinylcyclohexane, 1,3-divinylcyclopentane, 1,5-divinylcyclooctane, 1-allyl-4-vinylcyclo-hexane, 1,4 diallyl cyclohexane, 1-allyl-5-vinylcyclooctane, 1,5-diallylcyclooctane, 1-allyl-4-isopropenyl-cyclohexane, 1-isopropenyl-4-vinylcyclohexane and 1-isopropenyl-3-vinylcyclopentane, dicyclopentadiene and 1,4-cyclohexadiene. Preferred are non-conjugated vinyl norbornenes and C₈-C₁₂ alpha omega linear dienes. (e.g., 1,7-octadiene, 1,8-nonadiene,1,9-decadiene, 1,10 undecadiene, 1,11 dodecadiene). The dual polymerizable dienes may be further substituted with at least one group comprising a heteroatom of group 13-17 for example O, S, N, P, Cl, F, I, Br, or combinations thereof. Dual polymerizable dienes may cause or contribute to the formation of polymer branches.

In a preferred embodiment of the present disclosure the dual polymerizable diene is selected from, 2,5-norbornene, 5-vinyl-2-norbornene (VNB), 1,7-octadiene and 1,9-decadiene with 5-vinyl-2-norbornene (VNB) being most preferred. In one embodiment the copolymer of the present disclosure contains only VNB as dual-polymerizable diene.

Preferably, the copolymer of the present disclosure contains from 0.05 wt. % to 5 wt. %, more preferably from 0.10 wt. % to 3 wt. %, or from 0.2 wt. % to 1.2 wt. % of units derived from the one or more dual polymerizable diene, more preferably from VNB (all weight percentages are based on the total weight of ethylene-α-olefin-copolymer).

In a preferred embodiment, the copolymer of the present disclosure contains units derived from 5-ethylidene-2-norbornene and 5-vinylnorbornene. In a more preferred embodiment of the present disclosure the copolymer contains units derived from ethylene, propylene, 5-ethylidene-2-norbornene and 5-vinyl-2-norbornene. For example, the ethylene-α-olefin-copolymer, may contain from 5 to 20 wt. % of units derived from ENB and from 0.05 to 5 wt. % of units derived from VNB.

The ethylene-α-olefin-copolymer according to the present disclosure may or may not contain units derived from other comonomers. The sum of units derived from ethylene, non-conjugated diene(s), dual polymerizable dienes(s) and α-olefin(s) is greater than 99 wt. %, and preferably is 100 wt. % based on the total weight of the ethylene α-olefin-copolymer. In one embodiment of the present disclosure the sum of units derived from ethylene, propylene, ENB is higher than 75% by weight based on the total weight of the ethylene-α-olefin-copolymer polymer, preferably greater than 90% by weight and more preferably at least 95% by weight.

The ethylene-α-olefin-copolymer according to the present disclosure preferably has a high Mooney viscosity, for example a Mooney viscosity ML 1+8 at 150° C. of at least 80 or at least 90 or at least 100 and may in fact have a Mooney viscosity of even greater than 150. For example, the copolymer may have a Mooney viscosity ML 1+8 at 150° C. of 80 to 120 or of 80 to 150.

The ethylene-α-olefin-copolymer according to the present disclosure preferably has a weight average molecular weight (Mw) of at least 400,000 g/mole, preferably at least 500,000 g/mole and more preferably at least 600,000 g/mole. For example, the polymer may have an Mw of between 400,000 g/mole and 700,000 g/mole. The ethylene-copolymer of the present disclosure may have a molecular weight distribution or polydispersity of at least 2.5, for example from 3.0 to 30, or from 3.5 to 25 or from 3.7 to 10. In one embodiment of the present disclosure the number-averaged molecular weight (Mn) of the ethylene-copolymers of the present disclosure may be from about 40 to 230 kg/mole. Mw and Mn can be determined by gel permeation chromatography.

The ethylene-α-olefin-copolymer according to the present disclosure may be branched, for example with a branching level of 46 between 2 and 50, more preferably with a 46 between 5 and 35 or between 8 to 30, or between 10 to 25.46, expressed in degrees, is the difference between the phase angle δ at a frequency of 0.1 rad/s and the phase angle δ at a frequency of 100 rad/s, as determined by Dynamic Mechanical Spectroscopy (DMS) at 125° C.

Preferably, the ethylene α-olefin-copolymer according to the present disclosure has a diene content per polymer chain of at least 80, preferably of at least 95 and more preferably of at least 100 and preferably the diene contains ENB. The ethylene-α-olefin-copolymer according to the present disclosure may have a diene content per polymer chain of from about 80 up to about 125.

In a preferred embodiment the ethylene-α-olefin-copolymer according to the present disclosure has an ENB content per polymer chain of at least 80, preferably of at least 95 and more preferably of at least 100. In one embodiment of the present disclosure the ethylene-α-olefin-copolymer may have an ENB content per polymer chain of from about 80 up to about 125.

In one embodiment of the present disclosure the ethylene copolymer has a content of units derived from ENB between 5 and 20% by weight based on the total weight of the copolymer and a branching level expressed as 46 between 10 and 25. Such copolymer preferably has from 5 to 20% by weight of units derived from 5-ethylidene-2-norbornene (ENB) and from 0.05 to 5 wt. % of units derived from 5-vinyl-2-norbornene (VNB). Preferably, such copolymer has a high Mooney viscosity, for example a Mooney viscosity ML 1+8 at 150° C. of at least 90 or at least 100 and may in fact have a Mooney viscosity of even greater than 150. Preferably, the copolymer of this embodiment has an Mw of between 400,000 g/mole and 700,000 g/mole and/or a polydispersity of at least 2.5, for example from 3.0 to 30. The copolymer according to this embodiment may have a number-averaged molecular weight (Mn) from about 40 to 230 kg/mole.

The ethylene-α-olefin-copolymer according to the present disclosure can be processed into compounds with good or even improved dynamic and mechanical properties, preferably when mixed with low amounts of oil, for example as oil-extended copolymer. The oil-extended ethylene-α-olefin-copolymer has the same properties as the ethylene-α-olefin-copolymer described above except that the Mooney viscosity of the oil-extended copolymer is lower than the Mooney viscosity of the non-oil-extended copolymer. Therefore, in the present disclosure there are also provided compositions comprising one or more of the ethylene copolymers of the present disclosure mixed with oil. The oil is preferably incorporated into the polymer. Preferably the mixture is a solid mixture. Preferably the mixture is homogeneous. The terms “solid” and “homogeneous” refer to the visible appearance through the naked eye. Solid and homogeneous mixtures of oil and polymer preferably comprise the ethylene-copolymer in oil-extended form, i.e. the ethylene-copolymer is oil extended. For example, the oil-extended copolymer may be obtained by mixing the copolymer and oil during or after the polymerization process in a reaction medium and before removing the reaction medium. The amount of oil may range from more than 0 and up to 29 phr. Therefore, there are provided compositions comprising the copolymer of the present disclosure mixed with oil and having a total amount of oil of from 5 to 25 phr, preferably from 10 to 20 phr. Preferably, the oil comprises one or more hydrocarbon-based oil(s). Preferably, the copolymer mixed with oil is an oil-extended copolymer. Preferably, the oil of the composition is the extender oil of the oil-extended copolymer. Preferably, at least a major part of the oil, i.e. more than 50% by weight of the oil based on the total amount of oil, is extender oil, i.e. the oil of the oil-extended copolymer.

In one embodiment according to the present disclosure there is provided a composition comprising the ethylene-α-olefin-copolymer mixed with oil and the total oil content of the composition is from 5 to 25 wt. preferably from 8 and up to 20 wt. % or from 8 and up to 18 wt. % based on the total weight of the composition. Preferably, the oil comprises one or more hydrocarbon-based oil(s). Preferably, the copolymer mixed with oil is an oil-extended copolymer. Preferably, the oil of the composition is the extender oil of the oil-extended copolymer. Preferably, at least a major part of the oil, i.e. more than 50% by weight of the oil based on the total amount of oil, is extender oil, i.e. the oil of the oil-extended copolymer.

Typically, a composition comprising the ethylene-α-olefin-copolymer according to the present disclosure contains from 60% by weight, preferably from 90% by weight, more preferably from 95% by weight or even at least 97% by weight of ethylene-copolymer and oil (the weight percentages are based on the total weight of the composition which is 100%). Preferably, the oil comprises one or more hydrocarbon-based oil. Preferably, ethylene-α-olefin-copolymer is oil-extended. Preferably, the oil of the composition is the extender oil of the oil-extended copolymer. Preferably, at least a major part of the oil, i.e. more than 50% by weight of the oil based on the total amount of oil, is extender oil, i.e. the oil of the oil-extended copolymer.

The mixtures of oil and copolymer, for example the oil-extended ethylene-α-olefin-copolymer according to the present disclosure, typically are solid compositions and homogeneous mixtures of oil and polymer. They may be prepared by blending the ethylene-copolymer and at least a part of the oil, preferably all of the oil in liquid phase, preferably during the preparation of the polymer to provide an oil-extended copolymer. The oil that may be used can be any conventional oil or softening agent that is known in the art of producing rubbers as ‘extender oil’. The oil, preferably comprises one or more hydrocarbon-based oil(s) or. is hydrocarbon-based oil or a mixture thereof. “Hydrocarbon-based” means the oil contains at least 50% by weight based on the total composition of the oil of hydrogen and carbon. The hydrocarbon-based oil may contain preferably at least 90% by weight, more preferably at least 95% by weight of carbon and hydrogen. Preferably the oil is liquid at 25° C. and atmospheric pressure (1 atm). Examples of suitable oils include hydrocarbon-based oils, for example those obtained from high boiling fractions from petroleum. Specific examples include oils based mainly on alkanes and/or cycloalkanes like paraffinic oils, naphthenic oils, mineral oils. Suitable oils also include aromatic oils for example those obtained from boiling fractions of petroleum. The oils generally show a dynamic viscosity of from 5 to 35 mm²/s at 100° C. Preferred oils include paraffinic oils. Suitable oils are commercially available for example under the trade designation PLI PROCESS OIL P 460SUNPAR 2280, available from Sunoco, CONOPURE 12P, available from ConocoPhillips, PARALUX 6001 available from Chevron Texaco. Other examples include oils made via a gas to liquid (GTL) process, like e.g. RISELLA X 430 from Shell. The oils may contain olefin oligomers, for example homo-oligomers or co-oligomers of olefins, preferably alpha-olefin oligomers. In one embodiment the oil contains one or more alpha olefin oligomer or polymer and exhibits one or more of the following properties: a. a viscosity at a temperature of 190° C. (Brookfield Viscosity) of 90,000 mPa·sec or less or 80,000 or less, or 70,000 or less, or 60,000 or less, or 50,000 or less, or 40,000 or less, or 30,000 or less, or 20,000 or less, or 10,000 or less, or 8,000 or less, or 5,000 or less, or 4,000 or less, or 3,000 or less, or 1,500 or less, or between 250 and 15,000 mPa·sec, or between 500 and 5,500 mPa·sec, or between 500 and 3,000 mPa·sec; and/or b. a viscosity at a temperature of 60° C. from 200 mPa·sec to 20.000 mPa·sec, from 400 to 20.000 mPa·sec or from 500 to 20.000 mPa·sec or from 1,000 to 10.000 mPa·sec determined according to ASTM D3236. In one embodiment, the olefin oligomers are reactive with the polymer during the polymerization and may be incorporated into the polymer chain during the polymerization process.

In another preferred embodiment according to the present disclosure there is provided a composition comprising the ethylene-α-olefin-copolymer of the present disclosure and more than 0 and up to 29 phr, preferably from 5 to 25 phr, more preferably from 10 to 20 phr of oil, wherein the composition has a Mooney viscosity ML 1+8 at 150° C. of from about 80 to about 120, preferably for example from about 85 to about 110. Preferably, the oil comprises one or more hydrocarbon-based oil(s). Advantageously, the composition may have a delta min (δₘᵢₙ) of greater than 1 and less than 4.0 preferably less than 3.70 and more preferably less than 3.20. For example, the ethylene-α-olefin-copolymer according to the present disclosure may have a delta min(δₘᵢₙ) of greater than 2.0 and lower than 3.5. Preferably, ethylene-α-olefin-copolymer is oil-extended. Preferably, the oil of the composition is the extender oil of the oil-extended copolymer. Preferably, at least a major part of the oil, i.e. more than 50% by weight of the oil based on the total amount of oil, is extender oil, i.e. the oil of the oil-extended copolymer.

In one embodiment of the present disclosure there is provided a composition comprising an ethylene copolymer having a content of units derived from ENB between 5 and 20% by weight based on the total weight of the copolymer and a branching level expressed as 46 between 10 and 25. Such copolymer preferably has from 5 to 20% by weight of units derived from 5-ethylidene-2-norbornene (ENB) and from 0.05 to 5 wt. % of units derived from 5-vinyl-2-norbornene (VNB). Preferably, such copolymer has a high Mooney viscosity, for example a Mooney viscosity ML 1+8 at 150° C. of at least 90 or at least 100 and may in fact have a Mooney viscosity of even greater than 150. Preferably, the copolymer of this embodiment has an Mw of between 400,000 g/mole and 700,000 g/mole and/or a polydispersity of at least 2.5, for example from 3.0 to 30. The copolymer according to this embodiment may have a number-averaged molecular weight (Mn) from about 40 to 230 kg/mole. The composition of this embodiment has a total content of oil of up to 29 phr of oil. Preferably, the ethylene-copolymer is oil-extended. Preferably, the oil of the composition is the extender oil of the oil-extended copolymer. Preferably, at least a major part of the oil, i.e. more than 50% by weight of the oil based on the total amount of oil, is extender oil, i.e. the oil of the oil-extended copolymer.

### Polymer Preparation

The copolymers according to the present disclosure can be prepared by a process comprising copolymerizing ethylene, at least one C₃-C₂₀-α-olefin, at least one non-conjugated diene and, optionally, at least one dual polymerizable diene monomer as known in the art of producing ethylene-copolymers. The polymers may be produced by using conventional catalysts, like for example Ziegler-Natta-catalysts or metallocene-type catalysts or post metallocene catalysts or by a combination of catalysts. Ziegler-Natta catalysts are non-metallocene type catalysts based on halides of transition metals, in particular titanium or vanadium. Metallocene-type catalysts are organometallic catalysts wherein the metal is bonded to at least one cyclic organic ligand, preferably at least one cyclopentadienyl or at least one indenyl ligand. In one embodiment a Ziegler-Natta catalyst is used. In another embodiment, preferably a metallocene-type catalyst is used. In another embodiment a combination of two or more metallocene-type catalysts is used.

The polymerization can be carried out in the gas phase, in a slurry, or in solution in an inert solvent, preferably a hydrocarbon solvent.

The polymerisation can take place in different polymerization zones. A polymerization zone is a vessel where a polymerization takes place and could be either a batch reactor or a continuous reactor. When multiple reactors are employed (for example multiple reactors connected in series or in parallel), each reactor is considered as a separate polymerisation zone.

Preferred solvents include one or more hydrocarbon solvent. Suitable solvents include C₅₋₁₂ hydrocarbons such as pentane, hexane, heptane, octane, cyclohexane, methylcyclohexane, pentamethyl heptane, hydrogenated naphtha, isomers and mixtures thereof. The polymerization may be conducted at temperatures from 10 to 250° C., depending on the product being made. Most preferably the polymerisation is performed at temperatures greater than 50° C., if performed in solution.

In a preferred embodiment the polymerization includes the use of one or more chain transfer agent to control the molecular weight of the polymer. A preferred chain transfer agent includes hydrogen (H₂). The diene content per polymer chain can be controlled, for example, by controlling the amount of dienes in the reaction and the molecular weight (chain length) as known in the art. Branching can be introduced as known in the art, for example by using specific catalysts, for example catalysts that create branches in the polymer, such as for example vinyl group creating catalysts, or by using monomers that create polymer branching, for example dual polymerizable dienes or by using a combination of both. The degree of branching can be controlled, for example, by adjusting their amounts or feed streams during the polymerization as is known in the art. The minimum phase angle can be controlled by the degree of long-chain branching.

Oil-extended ethylene copolymers are preferably obtained by blending one or more extender oils with the ethylene-copolymer during the polymer preparation and prior to working up the polymer, more specifically prior to removing the solvent. Preferably the one or more oil is added to the reaction solution after it has left the reaction vessel and/or after the polymerization reaction has been terminated to produce the oil-extended polymer and before the solvent of the reaction solution is removed. For example, the addition may takes place after the polymerization reactor, but before the removal of volatiles, for instance before a steam stripper or a dry finishing extruder. Preferably the extender oil is blended with the ethylene-α-olefin copolymer when it is dissolved or suspended in the reaction media, preferably coming from the polymerization reactor.

### Ethylene-Copolymer Compounds

The ethylene-copolymers according to the present disclosure, preferably compositions comprising the copolymer according to the present disclosure mixed with oil, more preferably the oil-extended copolymers, may be combined with one or more additional ingredients. Such additional ingredients include but are not limited to (a) one or more than one curing agent, (b) one or more than on filler, (c) one or more than one rubber auxiliaries. The ethylene-copolymers and the oil-extended compositions can be mixed with such ingredients to provide rubber compounds to produce rubber compounds, which typically are homogeneous, solid mixtures of the rubbers and the further ingredients. In rubber compounds, typically, the content of ingredients other than ethylene-copolymer and oil is at least or greater than 10 wt. % based on the total weight of the composition. The rubber compounds are curable and can be cured to provided vulcanized compounds or “vulcanizates”.

### Curing Agents

Suitable curing (vulcanizing) agents include but are not limited to sulfur, sulfur chloride, sulfur dichloride, 4,4′-dithiodimorpholine, morpholine disulfide; alkylphenol disulfide, tetramethylthiuram disulfide (TMTD), tertaethylthiuram disulfide (TETD), selenium dimethyldithiocarbamate, and organic peroxides. Organic peroxides include but are not limited to dicumyl peroxide (DCP), 2,5-di(t-butylperoxy)-2,5-dimethyl-hexane (DTBPH), di(t-butylperoxyisopropyl)benzene (DTBPIB), 2,5-di(benzoylperoxy)-2,5-dimethylhexane, 2,5-(t-butylperoxy)-2,5-dimethyl-3-hexyne (DTBPHY), di-t-butyl-peroxide and di-t-butylperoxide-3,3,5-trimethylcyclohexane (DTBTCH) or mixtures of these peroxides. Of these, preferred are sulfur, TMTD, TETD, DCP, DTBPH, DTBPIB, DTBPHY and DTBTCH.

In case of sulfur vulcanization, sulfur or a sulfur-containing curing agent is preferably used in an amount of 0.1 to 10 phr, preferably from 0.5 to 5 phr or even more preferably 0.5 to 2 phr.

In case of peroxide vulcanization, the organic peroxide-based curing agent may be used in an amount from 0.1 to 15 phr, preferably from 0.5 to 5 phr.

Sulfur as vulcanizing agent may be used in combination with one or more vulcanization accelerators and one or more vulcanization activators. Examples of the vulcanization accelerators include but are not limited to N-cyclohexyl-2-benzothiazole-sufenamide, N-oxydiethylene-2-benzothiazole-sulfen-amide, N, N-diisopropyl-2-benzothiazole-sulfen-amide, 2-mercaptobenzothiazole, 2-(2,4-dinitrophenyl) mercaptobenzothiazole, 2-(2,6-diethyl-4-morpholinothio)benzothiazole, dibenzothiazyl-disulfide, diphenylguanidine, triphenylguanidine, di-o-tolylguanidine, o-tolyl-bi-guanide, diphenylguanidine-phthalate, an acetaldehyde-aniline reaction product, a butylaldehyde-aniline condensate, hexamethylenetetramine, acetaldehyde ammonia, 2-mercaptoimidazoline, thiocarbaniride, diethylthiourea, dibutylthiourea, trimethylthiourea, di-o-tolylthiourea, tetramethylthiuram monosulfide, TMTD, TETD, terabutylthiuram disulfide, dipentamethylenethiuram tetrasulfide, zinc dimethyldithiocarbamate, zinc diethyl-thiocarbamate, zinc di-n-butylthiocarbamate, zinc ethylphenyldithiocarbamate, zinc butylphenyldithiocarbamate, sodium dimethyldithlocarbamate, selenium dimethyldithiocarbamate, tellurium diethyldithiocarbamate, zinc dibutylxanthate and ethylenethiourea. The vulcanization accelerators, if used, are used preferably in an amount of from 0.1 to 10 parts by weight, and more preferably from 0.2 to 5 parts by weight and most preferably between 0.25 and 2 phr per 100 parts by weight of the ethylene-copolymer.

Examples of the vulcanization activators include but are not limited to metal oxides, such as magnesium oxide and zinc oxide, stearic acid or its metal salts stearic acid or combinations thereof like, for example zinc oxide combined with stearic acid. The vulcanization activators are used usually in amounts from 0.5 to 10 phr based on the ethylene copolymer, preferably in amounts from 0.5 to 5 phr.

When peroxide or a mixture of peroxides is used as the vulcanizing agent, peroxide cross-linking coagents may be used. Examples of such peroxide cross-linking coagent are cyanurate compounds, such as triallyl cyanurate and triallylisocyanurate, (meth)acrylate compounds, such as trimethylolpropane-trimethacrylate and ethyleneglyclol-dimethacrylate, zinc-dimethacrylate and zincdiacrylate, divinylbenzene, p-quinonedioxime, m-phenylene dimaleimide, (high vinyl) polybutadiene, and combinations thereof. Preferably, 0.1 to 5 phr of the peroxide cross-linking coagents may be used. More preferably from 0.25 to 2.5 phr of peroxide cross-linking coagent may be used. When peroxides are used as the vulcanizing agent in addition, preferably sulphur (elementary or as part of sulphur accelerators or sulphur donors) can be used to obtain so-called hybrid curing systems. These curing systems combine high heat resistant properties, typical for peroxide cure, with very good ultimate properties, such as tensile and tear, as well as excellent dynamic and fatigue properties typically associated with sulphur vulcanization systems. Applied dosing levels of sulphur are preferably from 0.05 to 1.0 phr, preferably from 0.2 to 0.5 phr.

### Fillers

Preferably the filler may be used in an amount of 20 to 500 phr. Preferred fillers include carbon black and/or inorganic fillers such as silica, calcium carbonate, talcum and clay, which are conventionally used for rubber. The type of carbon black is classified according ASTM D-1765 for its particle size (BET in m²/g) and structure (DBP adsorption in cm³/100 g). Preferably carbon black fillers are used with a BET number in from 5 to 150, and DBP numbers in from 30 to 140. In the industry these types of carbon blacks are often designated to by abbreviations, such as MT, SRF, GPF, FEF, HAF, ISAF, SAF. The inorganic fillers may be surface treated with suitable silanes. Combinations of two or more of such fillers may be used. Most preferably the filler comprises carbon black and/or silanized silica.

Further fillers may include one or more than one other rubber including EPDM rubbers, and rubber blends.

### Other Rubber Additives (Rubber Auxiliaries)

Other rubber additives include those commonly used in the art of rubber compounding. Examples include but are not limited to antioxidants (e.g., hindered phenolics such as commercially available under the trade designation IRGANOX 1010 or IRGANOX 1076 from BASF; phosphites (for example those commercially available under the trade designation IRGAFOS 168, dessicants (e.g. calcium oxide), tackifiers (e.g. polybutenes, terpene resins, aliphatic and aromatic hydrocarbon resins, alkali metal and glycerol stearates, and hydrogenated rosins and the like), bonding agents, heat stabilizers; anti-blocking agents; release agents; anti-static agents pigments; colorants; dyes, processing aids (e.g. factice, fatty acids, stearates, poly- or di-ethylene glycols), antioxidants, heat stabilisers (e.g. poly-2,2,4-trimethyl-1,2-dihydroquinoline or zinc 2-mercaptobenzimidazole), UV stabilisers, anti-ozonants, blowing agents and mould releasing agents, partitioning agents or processing aids like talc or metal salts, such as e.g. zinc stearate, magnesium stearate or calcium stearate and plasticizers (plasticizer lubricating oil, for example those commercially available under the trade designation PLI PROCESS OIL P460, paraffin, liquid paraffin, petroleum asphalt, vaseline, low molecular weight polyisobutylene or polybutylene, liquid EPDM or EPM, coal tar pitch, castor oil, linseed oil, beeswax, atactic polypropylene and cumarone indene resin). Plasticizers may be used in amounts from 20 to 250 phr. Rubber auxiliaries include plasticizers which may comprise one or more oil and the overall oil content in the rubber compounds may be higher than in the compositions used to make the compounds. Further additives as known in the art may also be used.

### Process of Making Rubber Compounds

Rubber compounds containing the ethylene-copolymer according to the present disclosure can be manufactured by mixing the ethylene-copolymer, preferably the composition containing the ethylene-copolymer mixed with oil, with one or more components, for example a) one or more curing agents described above, b) one or more filler described above and/or c) one or more rubber auxiliaries described above. A typical process for forming a vulcanizable rubber compound comprises mixing

(i) a composition comprising the ethylene copolymer mixed with oil, preferably as oil-extended ethylene-copolymer,
(ii) one or more curing agent,
(iii) one or more fillers,
(iv) one or more other rubber additives, preferably including at least one plasticizer, to form a vulcanizable rubber composition.

The mixing preferably comprises kneading, for example with conventional rubber mixing equipment including, for example, kneaders, open roll mills, internal mixers, or extruders. Mixing can be done in one or more steps as known to a man skilled in the art.

The ethylene-copolymers, and in particular the compositions containing the copolymer mixed with oil, preferably as oil-extended copolymers, may be used to prepare vulcanized rubber compounds or articles having at least two, preferably at least three and more preferably at least for or all of the following properties:

(a) a Shore A hardness of at least 40,
(b) a tensile strength at break of at least 10 MPa,
(c) an elongation at break of at least 400
(d) a tan delta of less than 0.16, preferably less than 0.15,
(e) a dynamic stiffness of less than 1.35, preferably less than 1.25,
(f) a rebound of at least 63% at 23° C. and at 60° C.

Generally, compounds can be prepared that have low compression sets, for example compression sets of less than 9 at 72 hours and 23° C.

### Articles and Applications

To produce articles the curable (vulcanizable) rubber compounds are subjected to at least one shaping step and are shaped, for example by extruding and/or moulding, and to at least one vulcanization step. The vulcanization may take place before, during or after shaping, for example during or after extrusion or moulding. Articles made by using the ethylene-copolymer according to the present disclosure contain the polymer in cured form, i.e. the polymer is cross-linked either with itself or with other cross-linkable ingredients in the compound or composition used to make the article, for example other curable rubbers. Therefore, there is provided a method of making an article comprising subjecting a rubber compound according to the present disclosure to shaping and curing, wherein shaping can be done after, prior to, or simultaneous with the curing. Therefore, there is also provided an article obtained by this method.

The ethylene-copolymers according to the present disclosure and the compositions and compounds containing them may be used in a variety of end-use applications, including any application suitable for EPDM polymers. Examples include but are not limited to hoses, belts, seals, engine mounts, a roofing material, or gaskets.

The ethylene-copolymers according to the present disclosure, including compounds made with them, may be particularly suitable as sealing materials or for making seals. Seals include solid seals. A solid seal means the material is not foamed and contrary to a foamed material does not contain a cellular or sponge-like structure. The ethylene-copolymers and compositions according to the present disclosure, including compounds made with them, may be particularly suitable for making foamed articles including sponge-like seals or foamed seals. In one embodiment of the present disclosure the article is a foamed article, more preferably a foamed seal and more preferably an article having a density of less than 1.0 g/cm³, for example a density between 0.4 and 0.8. In another embodiment of the present disclosure there is provided an article comprising the ethylene-copolymer of the present disclosure in a cured form wherein the article preferably is a solid seal, i.e. a non-foamed seal.

### LIST OF PARTICULAR EMBODIMENTS

The disclosure will now be illustrated further by a list of illustrative embodiments of the disclosure but with no intention to limit the disclosure to these illustrative embodiments listed below.

First illustrative embodiment: A composition comprising an ethylene copolymer comprising units derived from ethylene, at least one C₃-C₂₀ α-olefin, and at least one non-conjugated diene, wherein the copolymer contains
(i) up to and including 58% by weight based on the total weight of the copolymer of units derived from ethylene, preferably from 35 to 56% by weight and more preferably from 38 to 52% by weight;
(ii) up to and including 57% by weight, preferably from 17 to 55% by weight, based on the total weight of the copolymer of units derived from the at least one C₃-C₂₀ α-olefins, preferably from propylene;

wherein the ethylene copolymer has from about 80 up to about 125 units derived from the one or more diene per polymer chain and wherein the ethylene copolymer is mixed with oil and the total amount of oil in the composition is 29 phr or less and wherein the composition contains from 60% by weight to 100% by weight, based on the total weight of the composition which is 100%, of ethylene copolymer and oil.

Second illustrative embodiment: the composition of the first particular embodiment wherein the copolymer comprises 5-ethylidene-2-norbornene (ENB) as a non-conjugated diene.

Third illustrative embodiment: The composition according to the first or second illustrative embodiment wherein the copolymer comprises 5-ethylidene-2-norbornene (ENB) as a non-conjugated diene and wherein the ethylene copolymer has from 80 up to 125 units derived from ENB per polymer chain.

Fourth illustrative embodiment: The composition of any one of the preceding illustrative embodiments having a phase angle minimum δₘᵢₙ, of greater than 1 and less than 4.00, preferably less than 3.70 and more preferably less than 3.20.

Fifth illustrative embodiment: The composition of any one of the preceding illustrative embodiments wherein the composition has a Mooney viscosity ML 1+8 at 150° C. of from 80 to 120.

Sixth illustrative embodiment: The composition of any one of the preceding illustrative embodiments wherein the ethylene copolymer has a branching level expressed as 46 between 2 and 50.

Seventh illustrative embodiment: The composition of any one of the preceding illustrative embodiments wherein the ethylene copolymer has a content of units derived from ENB between 5 and 20% by weight based on the total weight of the copolymer and a branching level expressed as Δδ between 10 and 25.

Eights illustrative embodiment: The composition of any one of the preceding illustrative embodiments wherein the ethylene copolymer comprises from 5 to 20% by weight of units derived from 5-ethylidene-2-norbornene (ENB), from 0.05 to 5% by weight of units derived from 5-vinyl-2-norbornene (VNB), from 35 to 56% by weight of units derived from ethylene and from 17 to 55% by weight of units derived from propylene wherein all % by weight are based on the total weight of the copolymer and wherein the ethylene copolymer has from about 80 up to about 125 units derived from ENB and VNB per polymer chain and wherein the total amount of oil in the composition is 5 to 25 phr.

Nineth illustrative embodiment: The composition of any one of the preceding illustrative embodiments containing at least 90% by weight, preferably at least 95% by weight, based on the total weight of the composition which is 100%, of ethylene copolymer and oil wherein the total content of oil in the composition is up to 29 phr, preferably from 5 to 25 phr, and more preferably from 10 to 20 phr and wherein the oil comprises one or more hydrocarbon-based oil.

Tenth illustrative embodiment: A method of making a rubber compound comprising mixing the composition of according to any one of the preceding illustrative embodiment a with at least one curing agent, optionally at least one filler or a combination thereof.

Eleventh illustrative embodiment: A rubber compound obtained from the method according to illustrative embodiment 10.

Twelfth illustrative embodiment: A method of making an article comprising subjecting a rubber compound according to illustrative embodiment to shaping and curing, wherein shaping can be done after, prior to, or simultaneous with the curing.

Thirteenth illustrative embodiment: An article obtained by a method according to illustrative embodiment 12.

Fourteenth illustrative embodiment: The article according to illustrative embodiment 13 being a foamed article.

Fifteenth illustrative embodiment: The article according to illustrative embodiment 13 having at least two of following properties (i) to (iv): (i) a dynamic stiffness of less than 1.30, (ii) a tan delta of less than 0.15, (iii) an elongation at break of at least 500%, (iv) a compression set of less than 20, preferably less than 9, at 72 h and 23° C.

Sixteenth illustrative embodiment: A method of making a composition according to any one of illustrative embodiments 1 to 9 comprising
(i) polymerizing ethylene, the at least one C₃-C₂₀ α-olefins, and the at least one non-conjugated diene in a reaction medium to provide the ethylene-copolymer,
(ii) mixing the ethylene copolymer with one or more oil in the reaction medium,
(iii) removing the reaction medium to isolate the composition comprising the copolymer and the oil,
(iv) optionally, subjecting the composition to at least one of the steps selected from drying, shaping, compressing, washing and a combination thereof.

The disclosure will now be further illustrated by way of examples but with no intention to limit the disclosure to these examples and the embodiments used in the examples.

### Test Methods

### Polymer Testing

### Polymer Composition:

Fourier transformation infrared spectroscopy (FT-IR) was used to determine the composition of the copolymers according to ASTM D 3900 for the C2/C3 ratio and D 6047 for the diene content on pressed polymer films.

Δδ:

Polymer branching level was characterized by the parameter Δδ. Δδ, expressed in degrees, is the difference between the phase angle δ at a frequency of 0.1 rad/s and the phase angle δ at a frequency of 100 rad/s, as determined by Dynamic Mechanical Spectroscopy (DMS) at 125° C. and 10% strain. This quantity Δδ is a measure for the amount of long chain branched structures present in the polymer and has been introduced in H. C. Booij, Kautschuk+Gummi Kunststoffe, Vol. 44, No. 2, pages 128-130, which is incorporated herein by reference.

### Molecular Weights and Molecular Weight Distribution:

The molecular weight of the polymer (Mw), the number-averaged molecular weight of the polymer (Mn), the z average molecular weight (Mz) and the molecular weight distribution (MWD, defined as the ratio between Mw and Mn) of the ethylene-copolymers were determined by gel permeation chromatography (GPC/SEC-DV) using a Polymer Char GPC from Polymer Characterisation S. A. Valencia, Spain. The Size Exclusion Chromatograph was equipped with an on line viscometer (Polymer charV-400 Viscometer), an online infrared detector (IR % MCT), with 3 AGILENT PL OLEXIS columns (7.5×300 mm) and a Polymer Char autosampler. Universal calibration of the system was performed with polyethylene (PE) standards.

The polymer samples were weighted (in the concentration range of 0.3 to 1.3 mg/ml) into the vials of the PolymerChar autosampler. In the autosampler the vials were filled automatically with solvent (1,2,4-tri-chlorobenzene, TCB) stabilized with 1 g/I di-tert-butyl-paracresol (DBPC). The samples were kept in the high temperature oven (160° C.) for 4 hours. After this dissolution time, the samples were automatically filtered by an in-line filter before being injected onto the columns. The chromatograph system was operated at 160° C. The flow rate of the TCB eluent was 1.0 mL/min. The chromatograph contained a built-in on-line infrared detector (IR5 MCT) for concentration and built-in PolymerChar on-line viscometer. Universal calibration of the system was performed with polyethylene (PE) standards.

### Diene Units Per Chain:

The number of diene units (also referred to herein as ‘diene content’ or ‘units derived from dienes’) per polymer chain corresponds to:

$${\sum }_{i} \frac{[ diene ] i \times 10 \times Polymer Mn}{( Mw diene ) i}$$

where ‘[diene]’ means the content of diene i units in the polymer in wt. % (=the content of the units derived from the diene); ‘Polymer Mn’ means the number average molecular weight of the polymer, expressed in kg/mole; ‘Mw diene i’ means the molecular weight of the diene i molecule, expressed in g/mole.

In case the polymer contains units derived from several different dienes the total diene content per polymer chain is the sum of the content of the different dienes per chain. For example, the diene content per polymer chain of a polymer containing diene units derived from a diene A and a diene B the number of dienes per polymer chain is calculated according to the formula:

Number of dienes per chain={([diene A]×10×Polymer Mn)/Mw diene A}+{([diene B]×10×Polymer Mn)/Diene B Mw)}.

The number of ENB units per polymer chain corresponds to: ([ENB]×10×Polymer Mn)/120 g/mole, wherein ‘[ENB]’ is the content of ENB units in the polymer in wt. % (based on the total weight of the polymer which is 100%). 120 g/mole is the molecular weight of ENB. ‘Polymer Mn’ means the number average molecular weight of the polymer, expressed in kg/mole.

### Mooney Viscosity:

The Mooney viscosity was measured according to ISO 289.

### Phase Angle Minimum, δₘᵢₙ:

Ethylene-copolymers can be characterized by their curves in a van-Gurp-Palmen (vGP) plot. In a vGP plot the phase angle (6) is plotted versus the absolute modulus ([G*]). The phase angle and the absolute modulus are obtained from a rheological measurement that measures the temperature-dependent storage and loss moduli G′(T) and G″(T). The phase angle δ is calculated from tan G″/G′. The absolute modulus [G*] is calculated from the square root of the sum of (G′)²+(G″)², i.e.

|G*|=\sqrt{(G′)²+(G″)²}.

The point in the plot where the phase angle has a minimum is also a point where the absolute modulus [G*] has a minimum and can be used to characterize an ethylene-α-olefin copolymer (see for example M. van Gurp, J. Palmen, Time temperature superposition for polymeric blends, Rheol. Bull 67 (1998), 5 and S. Trinkle, C. Friedrich, Van Gurp-Palmen-plot: a way to characterize polydispersity of linear polymers, Rheol. Acta 40 (2001), 322. While the article from S. Trinkle et al refers to linear polymers only, the determination of delta min can also be used to characterize branched polymers).

To determine δₘᵢₙ the temperature-dependent storage and loss moduli, G′(T) and G″(T), were determined by Dynamic Mechanical Thermal Analysis (DMTA) measurements from −100° to +100° C. at 1 Hz frequency and 1 K/min heating rate using a Mettler Toledo DMA 861e rheometer, equipped with a double-sandwich simple shear sample holder. Test specimens with 8 mm diameter and 1 mm thickness were cut out from slabs compression molded for 10 min at 105° C. and 120 bar.

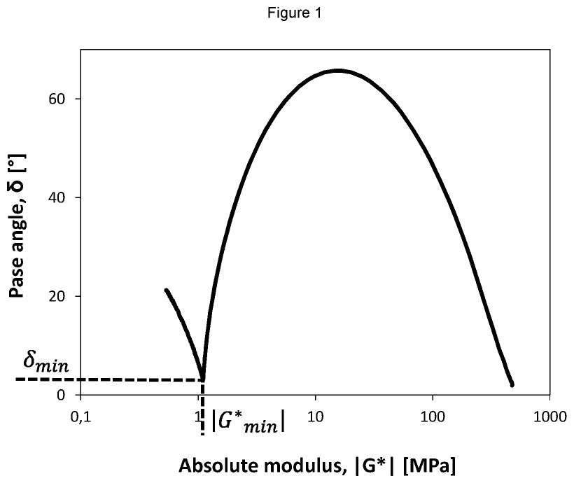

G′(T) and G″(T) were used to calculate the absolute modulus, |G*|=\sqrt{(G′)²+(G″)²}, and the phase angle, δ=tan G″/G′. The van Gurp-Palmen (vGP) plot shown in FIG. 1 was obtained by plotting S is plotted versus ICI of the measurements from example 1. The dashed lines in FIG. 1 indicate the minimum phase angle (δₘᵢₙ) and the corresponding absolute modulus, which is referred herein as G*ₘᵢₙ.

### Oil Content:

The oil content can be determined by extraction, for example, according to IS01407 from 2011, method D for non-vulcanized rubbers and method A for vulcanized rubbers.

### Compound Testing

### Mooney Viscosity:

Mooney viscosity (measuring conditions ML (1+4) @ 100° C.) of the curable compounds was determined according to DIN 53523-3 using NatureFlex NP/28 μm film manufactured by Putz Folien, D-65232 Taunusstein Wehen, Germany.

### Compression Set (CS):

The compression set (CS) were determined on cured compounds according to DIN ISO 815.

### Tensile Strength at Break (TS) and Elongation at Break (EB):

The tensile strength at break (TS) and the elongation at break (EB) were determined on a S2 dumbell at 23° C. on cured compounds according to DIN ISO 37.

### Hardness:

The shore A hardness (H) was determined on cured compounds according to DIN ISO 7629-1.

### Rebound:

Rebound resilience was measured at 23° C. according to DIN 53512.

### Tan Delta and Dynamic Stiffness:

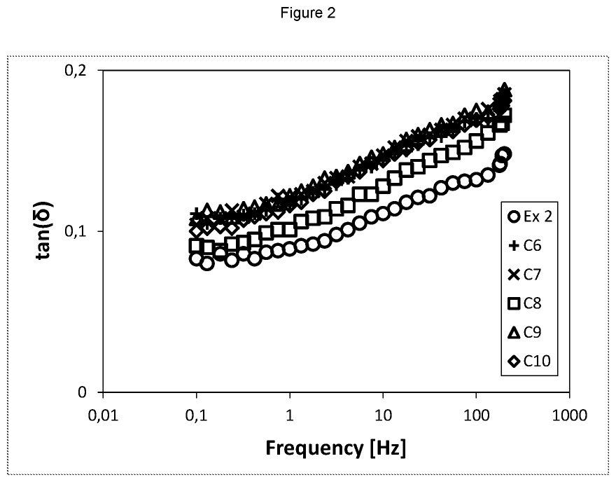

A dynamic-mechanical analyser from MTS Systems Cooperation was used. Two test specimens (6 mm in height and 20 mm diameter) were placed into a double shear sandwich sample holder and equilibrated at 60° C. for at least 30 min before the measurement was started. Thereafter, the linear viscoelastic properties of the rubber material were probed in simple shear geometry for frequencies in the range from 0.1 to 200 Hz (logarithmic scaling with 8 data points per decade) applying a peak-to-peak amplitude of 0.3 mm. The results are shown in FIG. 2. Tan delta was determined at 200 Hz. The dynamic stiffness, DS, was obtained from the ratio of the absolute moduli measured at 180 Hz and 10 Hz: DS=|G*(180 Hz)|/|G*(10 Hz)|.

### Tear Strength:

ISO 34-2 was applied measuring the tear resistance with Delft test specimens at 23° C.

### EXPERIMENTS

### Example 1 and Comparative Examples C1 to C5

The polymerization was carried by continuous polymerization essentially as described in the general continuous polymerization procedure of international patent application No. WO2005/090418, incorporated herein by reference, with compound 19 being used as catalyst. The polymerization was carried out in two liquid filled solution polymerization reactors connected in series. Both reactors had a volume of 3 L. The total system pressure was maintained above the degassing pressure in order to keep the full system in solution phase. The ethylene and alpha-olefin feeds and catalyst feed were adjusted to generate the content of units as indicated in table 1. The ENB feed was 988 mmol/h, the VNB feed was 61 mmoles/h and the hydrogen content were adjusted to 0.09 NL/h, to obtain the desired chain length, Mooney viscosity and diene per chain ratio. The polymer production rate was about 900 g/h. The polymer solution was continuously removed through a discharge line, where a solution of IRGANOX 1076 in iso-propanol was added. Paraffinic oil was added to the polymer solution and the solution of polymer (and oil) was worked up by continuous steam stripping. The oil-extended EPDM obtained was dried batch-wise on a 2-roll mill. The rheological properties of the polymer of example 1 (Ex 1) was compared with the properties of different EPDM polymers of different composition and structure (comparative examples, C1 to C6). The results are summarized in table 1.

TABLE 1
comparison of the polymer of Example 1 (Ex 1) with comparative polymers C1 to C6.

| Property | Unit | Ex 1 | C1 | C2 | C3 | C4 | C5 | C5A |
|---|---|---|---|---|---|---|---|---|
| ML(1 + 8)150° C. | MU | 94 | 52 | 62 | 48 | 54 | 56 | 81** |
| ML(1 + 4)125°X | MU | | 81 | 96 | 74 | 83 | | |
| δΔ | ° | 17 | 14 | 13 | 15 | 11 | 4 | |
| Units derived | % | 44.4 | 55.2 | 51.6 | 48.8 | 57.1 | 55.0 | 54** |
| from ethylene^{#} | | | | | | | | |
| Units derived | % | 8.5 | 10.6 | 9.8 | 10.2 | 8.4 | 9.5 | 8.5** |
| from ENB | | | | | | | | |
| Units derived | % | 0.46 | n.d. * | n.d. * | n.d. * | n.d. * | 0.73 | |
| from VNB | | | | | | | | |
| Oil | phr | 15 | 0 | 0 | 15 | 0 | 20 | |
| Mn | kg/mol | 155 | 84 | 75 | 88 | 70 | 66 | 67 |
| Mw | kg/mol | 620 | 310 | 340 | 410 | 310 | 420 | 460 |
| Mz | kg/mol | 1900 | 1300 | 1290 | 1800 | 1400 | 2000 | |
| MWD | | 4.0 | 3.7 | 4.5 | 4.7 | 4.4 | 6.4 | 6.9 |
| ENB/chain | units | 111 | 75 | 62 | 76 | 50 | 53 | 49 |
| δₘᵢₙ | ° | 2.98 | 4.29 | 4.35 | 4.35 | 5.09 | 4.80 | |

* n.d. = not detected; detection limit < 0.04%
**= ML(1 + 4)at 150° C. according to data sheet;
*** according to data sheet.

The polymers contained propylene as α-olefin comonomer. The content of units derived from propylene is not indicated in table 1 but makes up the rest of the polymer and can be calculated by 100% minus the total content of the units derived from ethylene, ENB and VNB— except for the polymer C5A. The amount of C₂ units was taken from the datasheet and may not be corrected for the diene content. The total amount of C₂ units (ethylene) and C₃ units (propylene) based on 100% wt of polymer may be somewhat lower.

Comparative examples C1 to C5A were commercial products and data was taken from public data sheets or determined experimentally. C1 was an EPDM sample available under the trade designation ROYALENE 547 from Lion Copolymer Geimar, LLC; C2 was an EPDM sample available under the trade designation KEP2480 from KUMHO POLYCHEM; C3 was an EPDM sample available under the trade designation VISTALON 8800 from ExxonMobil; C4 was an EPDM sample available under the trade designation VISTALON 8700 from ExxonMobil; C5 was an EPDM sample available under the trade designation EPT8120E from Mitsui Chemical Inc; C5A was an EPDM sample available under the trade designation ESPRENE 5527F from SumitomoChemical.

As can be seen from table 1 and as is known in the art, generally, the higher the Mooney viscosity, the higher is the molecular weight (Mw). The higher the Mw the higher is the number averaged molecular weight Mn. The Mn can be reduced by increasing the molecular weight distribution (MWD). The ENB content can be adjusted accordingly to achieve an ENB content per polymer chain above 80. For high molecular weight (Mw) and (Mn) lower amounts of ENB may be necessary than for lower molecular weight polymers.

The following additional commercial samples were analyzed for the content of units derived from ENB per polymer chain:

EPDM available under the trade designation KELTAN K8340A by ARLANXEO: ENB per polymer=chain 44;
EPDM available under the trade designation KELTAN K7341A by ARLANXEO: ENB per chain=63;
EPDM available under the trade designation VISTALON 7500 by Exxon: ENB per polymer chain=34.

### Example 2 and Comparative Examples C6 to C10

The polymers of example 1 and comparative examples C1 to C5 were compounded with the ingredients shown in table 2 by an internal mixer (GK1,5 E1 from Harburg-Freudenberger Maschinenbau GmbH; ram pressure 8 bar, 50 rpm, 72% degree of filling and total mixing time 5 min). The curing system was added on an open mill (200 mm roll diameter; 20 rpm, 40° C. roll temperature and friction).

TABLE 2
ingredients used for making EPDM rubber compounds.

| Ingredient | Amount, phr |
|---|---|
| EPDM polymer | 100 |
| Zinc oxide | 5 |
| Stearic acid | 2 |
| Carbon black | 50 |
| Oil | 45 |
| RHENOGRAN S-80 (80% sulfur) | 0.64 |
| RHENOGRAN TMTD-70 (70% | 1.25 |
| tetramethylthiuram disulfide) | |
| RHENOGRAN MBT-80 (80% | 0.42 |
| 2-mercaptobenzothiazole) | |
| Total loading | 204.31 phr |

The resulting EPDM compounds were tested for compound properties. Example 2 is the compound made with the polymer of example 1. Comparative examples C6 to C10 are the compounds obtained with polymers of comparative example C1 to C5.

Test specimens were prepared by curing test plates of 2 mm and 6 mm thickness at 180° C. for a time equivalent to 1.10 and 1.25 times t90 (t90 is the time to reach 90% of maximum torque during the rheometer measurement). The test results are shown in table 3.

TABLE 3
results of compound testing.

| Property | Unit | Ex 2 | C6 | C7 | C8 | C9 | C10 |
|---|---|---|---|---|---|---|---|
| Compound ML | MU | 80 | 48 | 47 | 51 | 45 | 58 |
| ΔS | dNm | 8.4 | 8.6 | 7.3 | 7.8 | 8.0 | 7.4 |
| Hardness | ShoreA | 48 | 46 | 45 | 45 | 46 | 45 |
| Tensile | MPa | 15.9 | 18.1 | 18.7 | 15.6 | 19.2 | 14.2 |
| Strength | | | | | | | |
| Elongation at | % | 637 | 675 | 724 | 677 | 727 | 537 |
| break | | | | | | | |
| Tear Strength | MPa | 23 | 24 | 24 | 23 | 26 | 23 |
| tan delta | — | 0.148 | 0.180 | 0.182 | 0.168 | 0.185 | 0.178 |
| Dynamic | — | 1.24 | 1.29 | 1.31 | 1.26 | 1.32 | 1.31 |
| stiffness | | | | | | | |
| Rebound 23° C. | % | 66.4 | 62.3 | 61.5 | 61.1 | 59.6 | 60.9 |
| Rebound 60° C. | % | 66.5 | 62.5 | 62.5 | 65.5 | 61.0 | 62.5 |
| CS 72 h/23° C. | % | 7 | 9 | 11 | 9 | 13 | 11 |

As can be seen from table 3 compounds prepared from the polymers according to the present disclosure have good mechanical strength as shown by the tensile at break and good elastic properties as shown by the elongation at break of greater than 500%. The compounds have good form-retaining properties as demonstrated by low compression set values. The compression sets were also low over a wide range of temperatures. The compounds made from the polymers of the present disclosure also had improved elastic and dynamic properties as indicated by high rebound values and low tan delta values. The compounds made from the polymers of the present disclosure also demonstrate excellent resilience as indicated by low dynamic stiffness values in table 3. Low dynamic stiffness values are particularly desired for vibration and noise attenuation and are also useful properties for sealing applications and for making foamed seals or sponge materials, in particular.

1. An ethylene copolymer containing
(i) from 35 up to and including 58% by weight of units derived from ethylene;
(ii) from 17 up to and including 57% by weight, of units derived from at least one C₃-C₂₀α-olefins, and wherein the at least one C₃-C₂₀ α-olefin comprises propylene;
(iii) from 5 to 20% by weight of units derived from 5-ethylidene-2-norbornene (ENB),
wherein the % by weight in (i) to (iii) are based on a total weight of the copolymer being 100% by weight and wherein the copolymer has more than 80 units derived from ENB per polymer chain determined according to the formula (I):
units derived from ENB=([ENB]×10×Polymer Mn)/120 g/mol (I)
wherein ‘[ENB]’ is the content of ENB units in the polymer in % by weight (based on the total weight of the polymer which is 100% by weight) and ‘Polymer Mn’ means the number average molecular weight (Mn) of the polymer, expressed in kg/mol.

2. The ethylene copolymer of claim 1, having a branching level expressed as Δδ between 5 and 20, wherein Δδ, expressed in degrees, is the difference between the phase angle δ at a frequency of 0.1 rad/s and the phase angle δ at a frequency of 100 rad/s as determined by Dynamic Mechanical Spectroscopy (DMS) at 125° C. and 10% strain.

3. The ethylene copolymer of claim 1, having a weight average molecular weight (Mw) of at least 400,000 g/mol as determined by gel permeation chromatography.

4. The ethylene copolymer of claim 1, having a content of units derived from ENB per polymer chain of from 95 to 120.

5. The ethylene copolymer of claim 1, wherein the ethylene copolymer further comprises from 0.05 to 5% by weight of units derived from 5-vinyl-2-norbornene (VNB) based on the total weight of the copolymer which is 100% by weight.

6. The ethylene copolymer of claim 1, wherein the ethylene copolymer contains from 35 to 56% by weight based on the total weight of the polymer of units derived from ethylene and wherein the ethylene copolymer has a content of units derived from ENB between 7 and 18% or from 8 to 15% by weight based on the total weight of the ethylene copolymer which is 100% by weight.

7. A composition comprising at least 60% by weight, based on a total weight of the composition which is 100% by weight, of the ethylene copolymer of claim 1, wherein the ethylene copolymer is mixed with oil and a total amount of oil in the composition is 29 phr or less. and wherein the oil optionally comprises one or more hydrocarbon-based oil.

8. The composition of claim 7, wherein the composition has a Mooney viscosity ML 1+8 at 150° C. of at least 80 as determined according to ISO 289.

9. The composition of claim 7, wherein the composition has a phase angle minimum δₘᵢₙ, of greater than 1 and less than 4.00, determined in a plot of the phase angle (δ) versus the absolute modulus ([G*]).

10. The composition of claim 7, having a Mooney viscosity ML 1+8 at 150° C. of from 80 and up to 150.

11. A method of making a rubber compound comprising mixing the ethylene-copolymer according to claim 1 a with at least one curing agent, optionally at least one filler and further optionally at least one blowing agent, or a combination thereof.

12. A rubber compound obtained from the method of claim 11.

13. A method of making an article comprising subjecting the rubber compound of claim 12 to shaping and curing, wherein shaping can be done after, prior to, or simultaneous with the curing.

14. An article obtained by the method of claim 13.

15. The article of claim 14, which is a foamed article.

16. The article of claim 14 having at least two of following properties (i) to (iv): (i) a dynamic stiffness of less than 1.30, (ii) a tan delta of less than 0.15, (iii) an elongation at break of at least 500%, (iv) a compression set of less than 20 at 72 h and 23° C.

17. A method of making an oil-extended polymer composition comprising
(i) polymerizing ethylene, at least one C₃-C₂₀ α-olefins, and the at least one non-conjugated diene in a reaction medium to provide an ethylene-copolymer as defined in claim 1,
(ii) mixing the ethylene copolymer with one or more oils in the reaction medium,
(iii) removing the reaction medium to isolate a composition comprising the copolymer and the oil,
(iv) optionally, subjecting the composition to at least one of the steps selected from drying, shaping, compressing, washing and a combination thereof.
